(19) United States
(12) Patent Application Publication
(10) Pub. No.: US 2014/0034410 A1
(43) Pub. Date: Feb. 6, 2014

(54) Rack Electric Power Steering Travel End Stops

(71) Applicants: Walter D. Jackson, Shelby Township, MI (US); Christopher J. Mielke, Shelby Township, MI (US); Scott R. Kloess, Rochester Hills, MI (US); George E. Doerr, Clarkston, MI (US); Marco E. Rodriguez, Macomb Township, MI (US)

(72) Inventors: Walter D. Jackson, Shelby Township, MI (US); Christopher J. Mielke, Shelby Township, MI (US); Scott R. Kloess, Rochester Hills, MI (US); George E. Doerr, Clarkston, MI (US); Marco E. Rodriguez, Macomb Township, MI (US)

(73) Assignee: GM GLOBAL TECHNOLOGY OPERATIONS LLC, Detroit, MI (US)

(21) Appl. No.: 13/562,434

(22) Filed: Jul. 31, 2012

(51) Int. Cl. B62D 5/04

(52) U.S. Cl. 180/444

(57) ABSTRACT

An electric power steering system equipped with rack travel end stops which prevent damage in the event of an over-speed condition. An abutment body is attached to each end of the power steering rack in externally concentric relation thereto so as to abut a respective housing abutment of the rack housing in the event of an over-speed condition of an electric power steering system and thereby eliminating tie rod assembly abutment with the housing.

### TECHNICAL FIELD

The present invention relates to motor vehicle electric power steering systems, and more particularly to travel end stops interfaced in external relation to the rack which provide an end of travel abutment in the event the power steering system is in an untoward over-speed condition of operation.

### BACKGROUND OF THE INVENTION

Electric power steering provides a steering assist to a motor vehicle driver as the driver turns the steering wheel in either direction of rotation. The electric motor of the electric power steering (EPS) system which serves to assist the steering by the driver can be connected to the rack of the steering system (an REPS system) or be connected to the steering column (a CEPS system), which are exemplified at FIGS. 1 through 3.

FIG. 1 depicts an example of a CEPS system. A motor vehicle 40 is provided with a steering column electric power steering system 24 which may comprise a conventional rack and pinion steering mechanism 36, which includes a toothed rack (not shown) and a column pinion gear (not shown) of a gear box 52. As the steering wheel 26 is turned, an upper steering shaft 29 turns a lower steering shaft 51 through a universal joint 34; and the lower steering shaft 51 turns the column pinion gear. Rotation of the column pinion gear moves the rack, which moves tie rods 38 (only one shown), which move steering knuckles 39 (only one shown) to turn tires 42 (only one shown).

The electric power assist is provided through a controller 16 and a power assist actuator comprising an electric motor 46. The controller 16 receives electric power from a vehicle electric power source 10 through a line 12, a signal representative of the vehicle velocity on line 14 and column pinion gear angle from a column rotational position sensor 32 on line 20. As the steering wheel 26 is turned, a torque sensor 28 senses the torque applied to steering wheel 26 by the vehicle operator and provides an operator torque signal to controller 16 on line 18. In addition, as the rotor of the electric motor 46 turns, rotor position signals for each phase are generated within the electric motor and provided over bus 30 to the controller 16. In response to the vehicle velocity, operator torque, column pinion gear angle and rotor position signals received, the controller 16 derives desired electric motor phase currents and provides such currents through a bus 22 to the electric motor 46, which supplies torque assist to steering shaft 29 through worm gear 47 and motor pinion gear 48. Details hereof are described in U.S. Pat. No. 5,982,067. An example of an embodiment of the controller 16 is described in U.S. Pat. No. 5,668,722.

FIGS. 2 and 3 depict an example of an REPS system. The rack electric power steering system 60 has a conventional rack and pinion steering mechanism 62 which includes a power steering rack 64 which is reciprocal within a rack housing 74. The rack 64 is connected to first and second tie rod assemblies 85, 87 which include first and second tie rods 80, 82 and first and second tie rod joints 88, 90, the connection being via internal threads 84, 86 of the rack. The steering column has a lower assembly 66 having a column pinion gear 68 which is meshed with the teeth 70 of the rack 64 so that turning of the steering column applies a torque at the toothed rack that results in the rack translating left or right, depending on the direction of the turning of the steering column. The electric motor 72 of the electric power steering system is connected (by gearing, belt, etc.) to a ball screw gear box 76 to a ball screw 78 of the rack 64. The electrical operation is as generally described with respect to FIG. 1, as it is adapted to the configuration of FIG. 1.

Under normal operating conditions, the electric power steering motor responsively assists the effort of the driver at the steering wheel to effect turning of the tires. However, an electric power steering system over-speed condition may arise, for example, if the motor vehicle is moving relative to an object and a tire is struck by the object, wherein the over-speed is the result of the motor vehicle speed relative to the struck object causing a rapid turning of the tire, and through the tie rods, back-driving the rotating components of the electric power steering system. In such a situation, the rotational speed of the electric power steering rotating components may become sufficiently excessive (an over-speed condition) that, at an abrupt end of travel event, possible damage to the components of the power steering system could occur due to the large rotational inertia of the power steering rotating components that is present at an abrupt end of travel.

As depicted at FIG. 4, the convention end of travel stop is for the tie rod joint 88 to strike the rack housing at a housing abutment 92 (this end of travel abutment being applicable, as well, to the ball screw side of the rack). However, in an over-speed situation, the impact of the tie rod joint striking the housing abutment can be severe enough to strip the inner threads 84 of the rack with respect to the threads 94 of the tie rod joint such that the threads are stripped and the tie rod joint is pulled out from its threadingly seated position in the rack (a similar scenario would pay-out at the ball screw side of the rack). The aftermath of such an untoward situation is costly damage to the rack and tie rod joint.

Therefore, what remains needed in the art is a mechanism that can prevent power steering system damage in the event of an over-speed condition of an electric power steering system. In this regard, while U.S. Pat. No. 8,177,018 successfully addresses this issue, it would be desirable if the mechanism could somehow be accomplished without moving parts.

### SUMMARY OF THE INVENTION

The present invention is a rack electric power steering system equipped with rack travel end stops which prevent damage in the event of an over-speed condition of the electric power steering system by providing an abutment body at each end of the power steering rack. Each abutment body is connected to the power steering rack in externally concentric relation thereto so as to abut a respective rack housing abutment of the rack housing in the event of an over-speed condition of an electric power steering system, eliminating tie rod assembly abutment with the housing. In this regard, each abutment body and its respective housing abutment form a rack travel end stop which precludes further travel of the rack relative to the rack housing.

In a preferred form of the present invention, at first end portion of the power steering rack, whereat is adjacently disposed the rack teeth, a first set of external threads is provided onto which is threaded a first abutment body. The first abutment body is sized to abut a first housing abutment of the rack housing in the event an over-speed condition of the electric power steering system, wherein the abutment occurs without the first tie rod joint striking the rack housing. The first abutment body and the first housing abutment form a first travel end stop which stops further travel of the rack relative to the housing.

Additionally with respect to the preferred form of the present invention, a second abutment body is secured to a second end portion of the power steering rack whereat is disposed the ball screw. In a connection modality, the second end portion is provided with a second set of external threads in substitution for the ball screw threads thereat, wherein the second abutment body is threaded thereon. In another connection modality, the second abutment body has threads configured for threading directly onto the screw treads of the ball screw and is then affixed thereto by crimping, a C-clip, a set screw of other affixment agency. In yet another connection modality, the second abutment body is provided with ball screw balls which thread onto the screw treads of the ball screw and is then affixed thereto by crimping, a C-clip, a set screw of other affixment agency. The second abutment body is sized to abut a second housing abutment of the rack housing in the event an over-speed condition of the electric power steering system, wherein the abutment occurs without the second tie rod joint striking the rack housing. The second abutment body and the second housing abutment form a second travel end stop which stops further travel of the rack relative to the housing.

Accordingly, it is an object of the present invention to provide an abutment body at each end of the power steering rack, wherein each abutment body is connected to the power steering rack in concentrically external relation thereto so as to abut a respective housing abutment in the event of an over-speed condition of an electric power steering system.

This and additional objects, features and advantages of the present invention will become clearer from the following specification of a preferred embodiment.

### BRIEF DESCRIPTION OF THE DRAWINGS

FIG. 1 is a schematic view of a prior art steering column electric power steering (CEPS) system.

FIG. 2 is a schematic view of a prior art rack electric power steering (REPS) system.

FIG. 3 is a partly sectional perspective view, detailing components of the prior art power steering system adjacent the first end portion of the art power steering rack.

FIG. 4 is a partly sectional end perspective view of the prior art power steering system similar to FIG. 3, wherein now an over-speed end of travel event has occurred in which the tie rod joint has impacted the housing resulting in the internal threading of the rack being stripped.

FIG. 5 is a schematic view of a rack electric power steering (REPS) system including a pair of abutment bodies in accordance with the present invention.

FIG. 6 is a perspective view of a first abutment body according to the present invention.

FIG. 7 is a perspective view of a second abutment body according to a first connection modality of the present invention.

FIG. 8 is a perspective view of a second abutment body according to a second connection modality of the present invention.

FIG. 9 is a perspective view of a second abutment body according to a third connection modality of the present invention.

FIG. 10 is a partly sectional perspective view, detailing components of the power steering system according to the present invention in adjacency to the first end portion of the art power steering rack.

FIG. 11 is a sectional view seen along line 11-11 of FIG. 10.

FIG. 12 is a partly sectional end perspective view of the power steering system similar to FIG. 10, wherein now an over-speed end of travel event has occurred in which the first abutment body has impacted the housing.

FIG. 13 is a partly sectional perspective view, detailing components of the power steering system according to the present invention in adjacency to the second end portion of the art power steering rack, wherein a first connection modality is used for the second abutment member.

FIG. 14 is a sectional view seen along line 14-14 of FIG. 13.

FIG. 15 is a partly sectional end perspective view of the power steering system similar to FIG. 13, wherein now an over-speed end of travel event has occurred in which the second abutment body has impacted the housing.

FIG. 16 is a partly sectional perspective view, detailing components of the power steering system according to the present invention in adjacency to the second end portion of the art power steering rack, wherein a second connection modality is used for the second abutment member.

FIG. 17 is a sectional view seen along line 17-17 of FIG. 16.

FIG. 18 is a partly sectional end perspective view of the power steering system similar to FIG. 16, wherein now an over-speed end of travel event has occurred in which the second abutment body has impacted the housing.

FIG. 19 is a partly sectional perspective view, detailing components of the power steering system according to the present invention in adjacency to the second end portion of the art power steering rack, wherein a third connection modality is used for the second abutment member.

FIG. 20 is a sectional view seen along line 20-20 of FIG. 19.

FIG. 21 is a partly sectional end perspective view of the power steering system similar to FIG. 19, wherein now an over-speed end of travel event has occurred in which the second abutment body has impacted the housing.

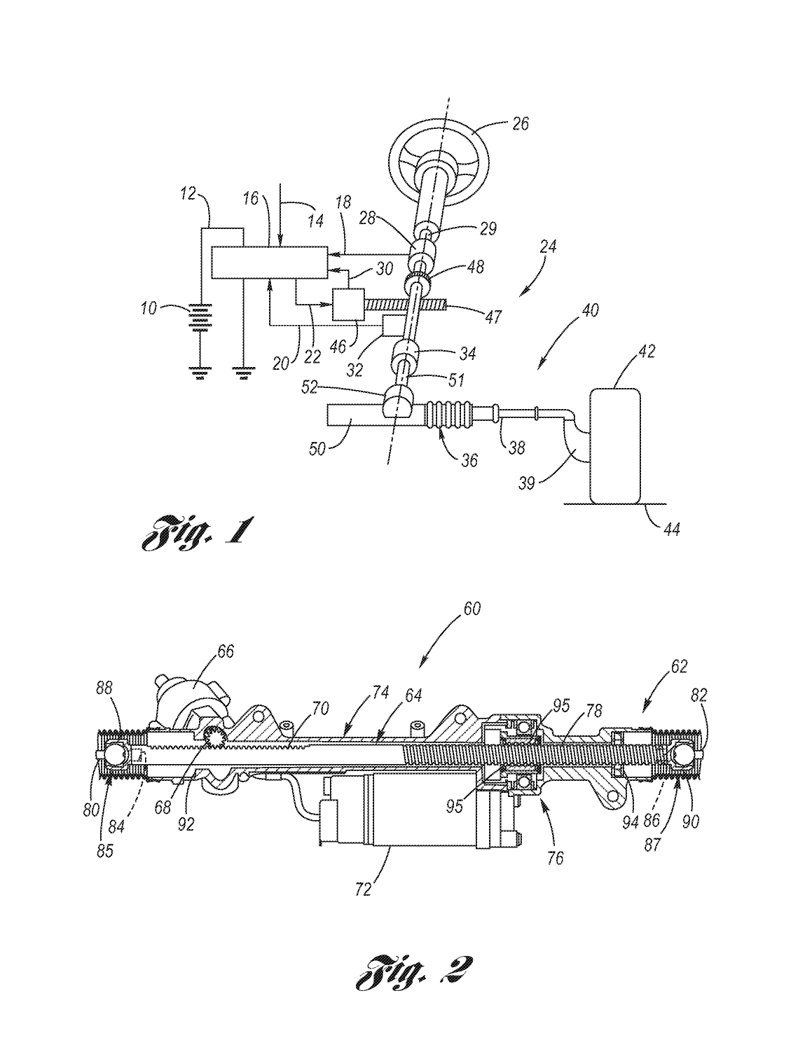

### DESCRIPTION OF THE PREFERRED EMBODIMENT

Referring now to the Drawings, FIGS. 5 through 21 depict various aspects of a power steering rack having rack travel end stops interfaced in external relation to the rack in accordance with the present invention.

Rack electric power steering systems, as for non-limiting example shown at FIG. 2, are vulnerable to high inertial momentum over-speed extreme travel events (i.e., when an externally induced rapid turning of the tires (wheels) is abruptly halted, yet the power steering components are at that moment in high speed rotation). This is because the momentum contained in high speed rotational inertia, if speed is high enough and end of travel is abrupt, involves a large force impulse which could be damaging to power steering components, in particular internal thread pull-out of the tie rod joint (discussed above).

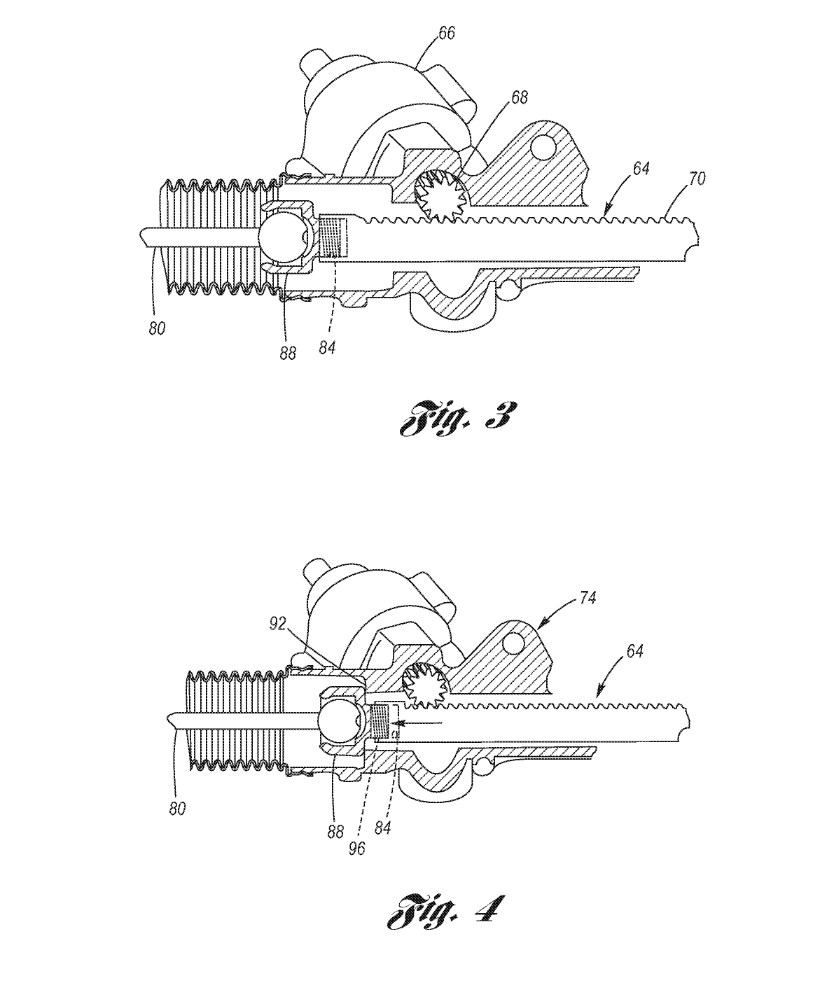

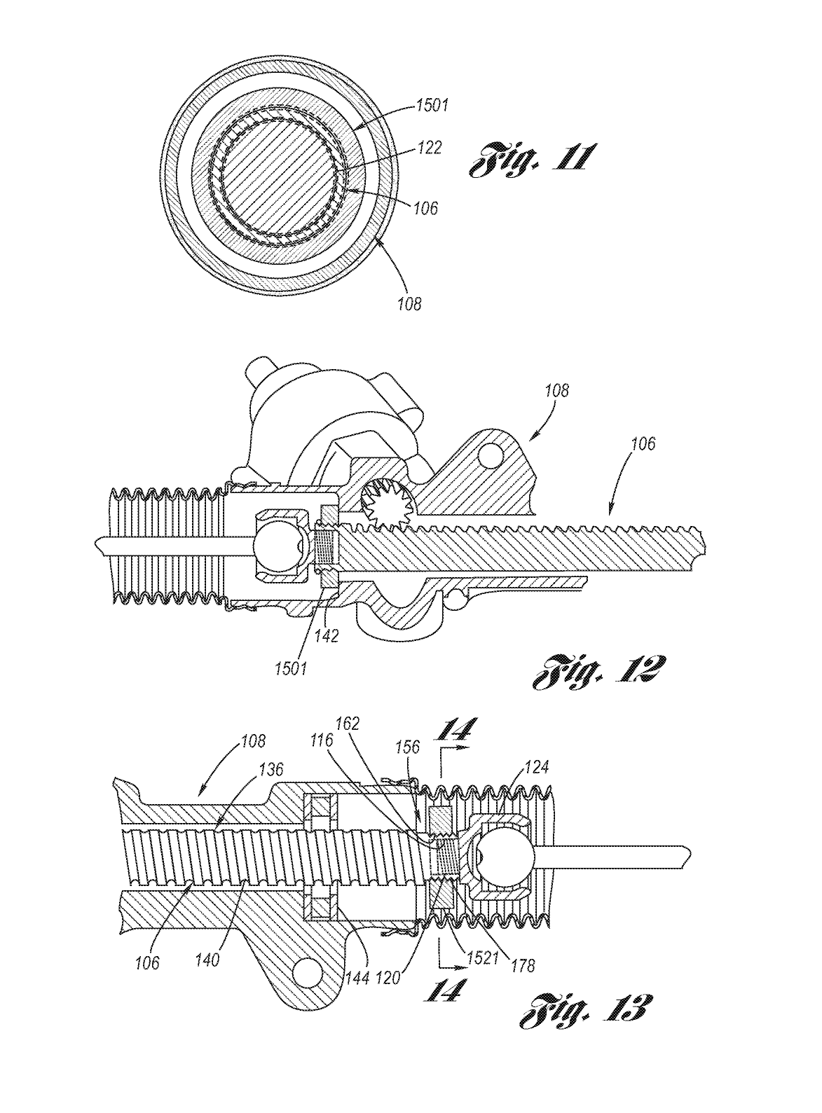

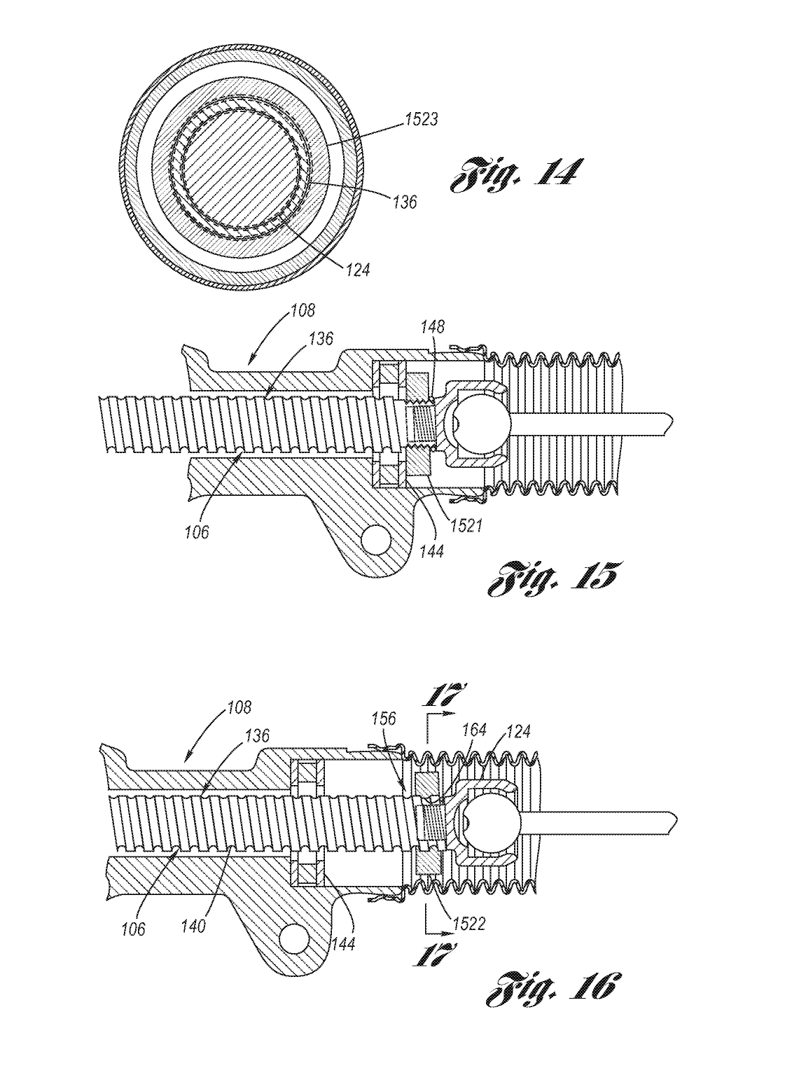

FIG. 5 depicts the power steering rack having rack travel end stops 100 according to the present invention. The rack electric power steering system 102, like that described above with respect to FIG. 2, has a conventional rack and pinion steering mechanism 104 which includes a power steering rack 106 that is disposed in an internal passage 103 of a rack housing 108 in reciprocally movable relation to the rack housing. The rack 106 is connected to the first and second tie rod assemblies 105, 107, which include first and second tie rods 110, 112 and first and second tie rod joints 122, 124, via internal threads 114, 116 of the rack being threadingly interfaced with threads 118, 120 of the first and second tie rod joints (see FIGS. 10 and 13). The steering column has a lower assembly 126 having a column pinion gear 128 which is meshed with the teeth 130 of the rack 106 so that turning of the steering column applies a torque at the rack that results in the rack translating left or right, depending on the direction of the turning of the steering column. The electric motor 132 of the electric power steering system is connected (by gearing, belt, etc.) through a ball screw gear box 134 to a ball screw 136 wherein ball screw balls 138 roll in ball screw threads 140 of the rack 106. The rack housing 108 has a first housing abutment 142 and a second housing abutment 144, wherein the first and second housing abutments are disposed within the internal passage 103, as for example similar to that shown at FIGS. 2 through 4.

Uniquely provided by the present invention are first and second abutment bodies 150, 152 which are attached to the rack in externally concentric relation thereto, respectively at the first and second end portions 154, 156 thereof. Accordingly, in the event of an over-speed condition of the electric power steering system, at a first extreme end of rack travel (see FIG. 12) the first abutment body 150 will abut the first housing abutment 154 without the first tie rod assembly abutting the housing, and at a second extreme of rack travel (see any of FIGS. 15, 18 and 21) the second abutment body 152 will abut the second housing abutment 156 without the second tie rod assembly abutting the housing (depending on the direction of the over-speed), wherein in either case no damage is incurred by either of the first and second tie rod assemblies 105, 107, inclusive of the threads 114, 116, 118, 120 (see FIGS. 10 and 13) connecting the first and second tie rod joints to the rack.

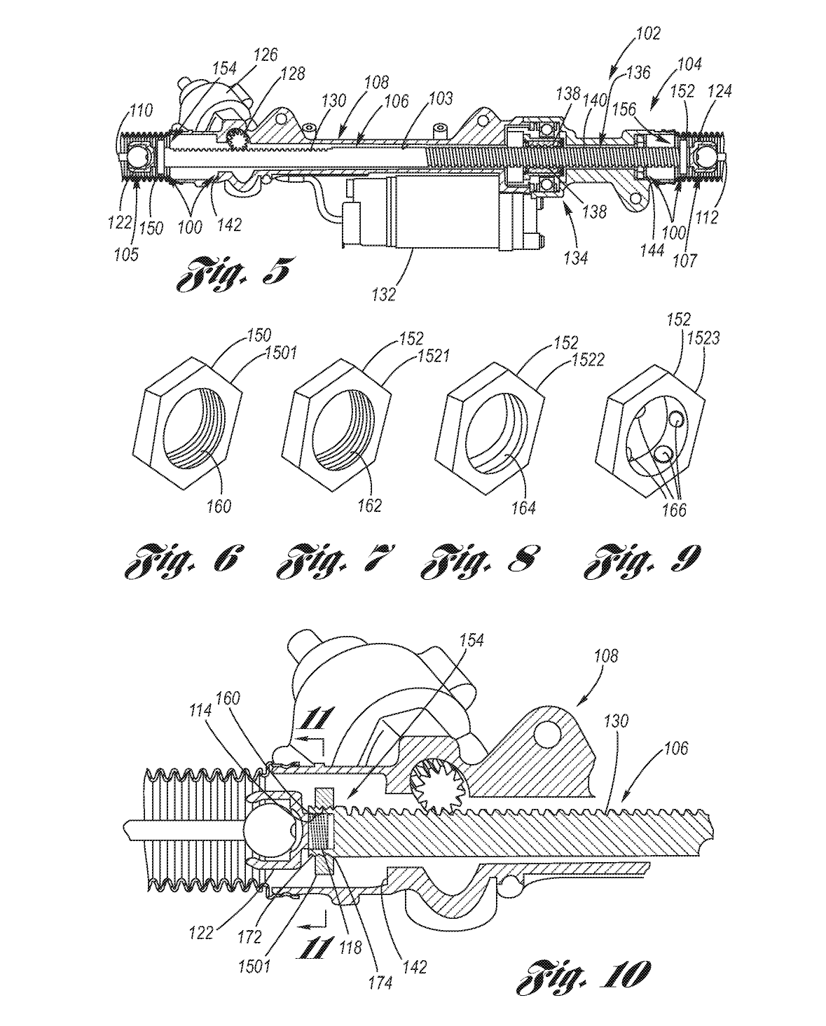

As depicted by FIGS. 6 through 8, the preferred first and second abutment bodies 150, 152 are nuts having an inner configuration for being mounted to the rack 106. By way of example, FIG. 6 depicts a first abutment body 1501 having first internal pipe threads 160; FIG. 7 depicts a second abutment body 1521 having second internal pipe threads 162, which may or may not be the same as the first internal pipe threads 160; FIG. 8 depicts a second abutment body 1522 having internal ball screw threads 164; and FIG. 9 depicts a second abutment body 1523 having internal ball screw balls 166.

Referring now to FIGS. 10 through 15, the structure and function of a power steering rack having rack travel end stops 100 utilizing the first and second abutment bodies 1501, 1521 of FIGS. 6 and 7 will now be detailed.

As shown at FIGS. 10 and 11, the first end portion 154 of the power steering rack 106, whereat is adjacently disposed the rack teeth 130, first external pipe threads 172 are provided on the outer diameter of the rack, which terminate at a first thread terminus 174 spaced from the rack teeth. The first abutment body 1501 is threaded onto the first external pipe threads 172, via the first internal pipe threads 160, in tight relation to the first thread terminus 174. The first abutment body 1501 is sized (has sufficient cross-sectional diameter) to abut the first housing abutment 142 of the rack housing 108 at the first extreme end of rack travel in the event of an over-speed condition of the electric power steering system. The threading position of the first abutment body 1501 in relation to the first thread terminus 174 may be attained merely by tightening at the first terminus, but may include any known thread affixment agency, such as threading putty, a set screw, a C-clip, locknut locking threads, etc.

In operation, as for example shown at FIG. 12, in the event of an over-speed condition of the electric power steering system, the first abutment body 150 abuttingly strikes the first housing abutment 142 without the first tie rod joint 122 striking the rack housing.

As shown at FIGS. 13 and 14, the second end portion 156 of the power steering rack 106 whereat is otherwise normally disposed the ball screw threads 140, second external pipe threads 178 are substituted therefor. By way of an implementing example, 14 mm of the ball screw threads are removed by turning down the outer diameter of the rack to at least the root of the ball screw threads in order to provide a smooth outer surface upon which the second external pipe threads 178 are provided, wherein a second thread terminus (which may take the form of a shoulder) 180 is formed by the process. The second abutment body 1521 is threaded onto the second external pipe threads 178, via the second internal pipe threads 162, in tight relation to the second thread terminus 180. The second abutment body 1521 is sized (has sufficient cross-sectional diameter) to abut the second housing abutment 144 of the rack housing 108 at the second extreme end of rack travel in the event of an over-speed condition of the electric power steering system. The threading position of the second abutment body 1521 in relation to the second thread terminus 180 may be by any known thread affixment agency, such as threading putty, a set screw, a C-clip (see C-clip 148 at FIG. 15) or locknut locking threads.

In operation, as shown at FIG. 15, in the event of an over-speed condition of the electric power steering system, the second abutment body 1521 strikes the second housing abutment 144 without the second tie rod joint 124 striking the rack housing.

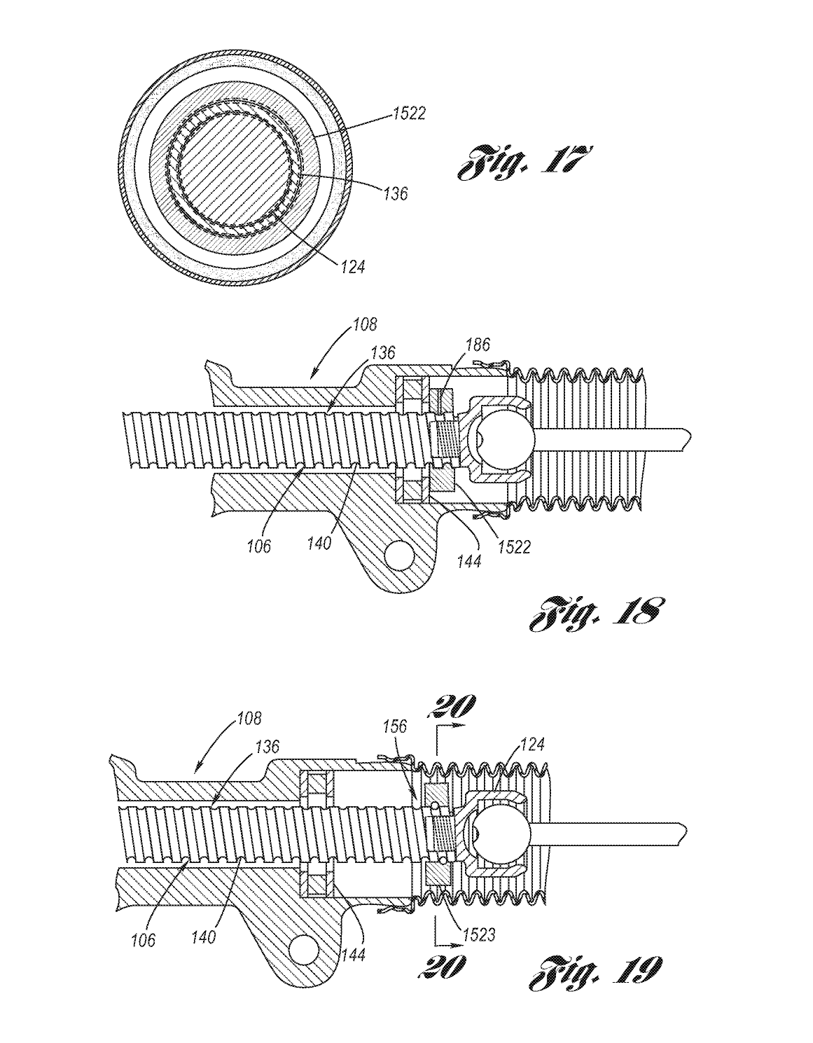

As shown at FIGS. 16 and 17, the second end portion 156 of the power steering rack 106 retains the ball screw threads 140 of the ball screw 136 without modification. The second abutment body 1522 is threaded onto the ball screw threads 140, via the internal ball screw threads 164. The second abutment body 1522 is sized (has sufficient cross-sectional diameter) to abut the second housing abutment 144 of the rack housing 108 at the second extreme end of rack travel in the event of an over-speed condition of the electric power steering system. The threading position of the second abutment body 1522 in relation to the ball screw threads 140 of the power steering rack 106 may be by any known thread affixment agency, such as threading putty, a set screw (see set screw 186 at FIG. 18), a C-clip, locknut locking threads, crimping, etc.

In operation, as shown at FIG. 18, in the event of an over-speed condition of the electric power steering system, the second abutment body 1522 strikes the second housing abutment 144 without the second tie rod joint 124 striking the rack housing.

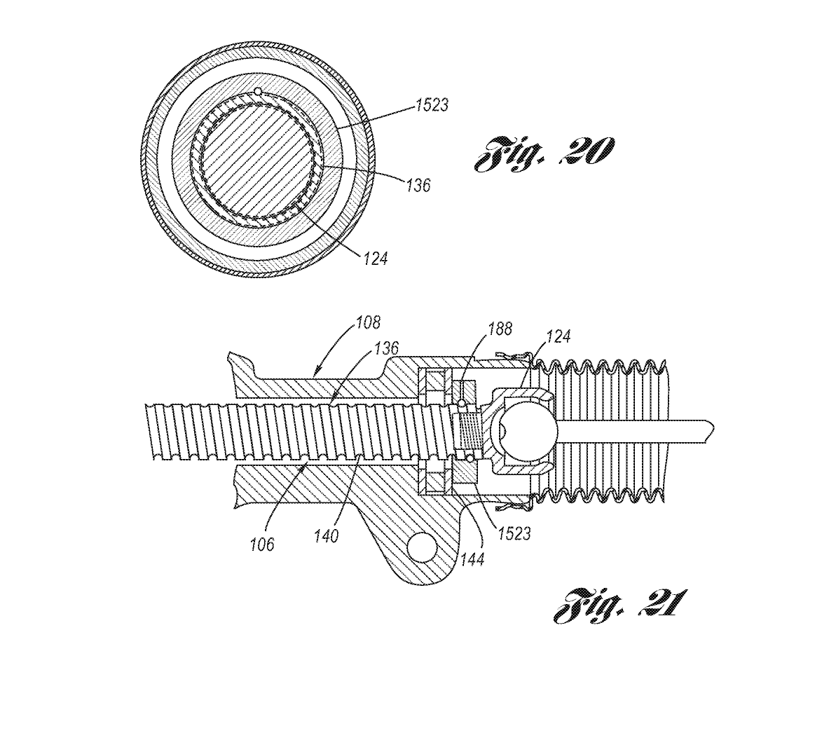

As shown at FIGS. 19 and 20, the second end portion 156 of the power steering rack 106 retains the ball screw threads 140 of the ball screw 136 without modification. The second abutment body 1523 is threaded onto the ball screw threads 140, via the internal ball screw balls 166. The second abutment body 1523 is sized (has sufficient cross-sectional diameter) to abut the second housing abutment 144 of the rack housing 108 at the second extreme end of rack travel in the event of an over-speed condition of the electric power steering system. The threading position of the second abutment body 1523 in relation to the ball screw threads 140 of the power steering rack 106 may be by any known thread affixment agency, such as threading putty, a set screw (see set screw 188 at FIG. 21), a C-clip, locknut locking threads, crimping, etc.

In operation, as shown at FIG. 21, in the event of an over-speed condition of the electric power steering system, the second abutment body 1523 strikes the second housing abutment 144 without the second tie rod joint 124 striking the rack housing.

To those skilled in the art to which this invention appertains, the above described preferred embodiment may be subject to change or modification. Such change or modification can be carried out without departing from the scope of the invention, which is intended to be limited only by the scope of the appended claims.

1. An electric power steering system with rack travel end stops, comprising:
a power steering rack, said rack having a first end portion and an oppositely disposed second end portion;
a rack housing having an internal passage, said rack being disposed in said internal passage in reciprocally movable relation with respect to said rack housing, said rack housing comprising a first housing abutment and a second housing abutment, said first and second housing abutments being disposed within said internal passage;
a first abutment body connected to said first end portion of said rack in concentrically external relation thereto; and
a second abutment body connected to said second end portion of said rack in concentrically external relation thereto;
wherein at a first extreme end of rack travel, said first abutment body abuts said first rack housing abutment to thereby stop rack travel at said first rack housing abutment; and
wherein at a second extreme end of rack travel, said second abutment body abuts said second rack housing abutment to thereby stop rack travel at said second rack housing abutment.

2. The electric power steering system with rack travel end stops of claim 1, wherein said first end portion of said rack is disposed adjacent rack teeth of said rack; and wherein the connection of said first abutment body to said first end portion of said rack comprises:
said first abutment body having first internal pipe threads; and
said first end portion of said rack having first external pipe threads;
wherein said first internal pipe threads of said first abutment body are threaded onto said first external pipe threads of said rack.

3. The electric power steering system with rack travel end stops of claim 2, wherein said first external pipe threads terminate at a first thread terminus spaced from the rack teeth; and wherein said first abutment body is tightly threaded in relation to said first thread terminus.

4. The electric power steering system with rack travel end stops of claim 2, wherein said second end portion of said rack is disposed at a ball screw of said rack; and wherein the connection of said second abutment body to said second end portion of said rack comprises:
said second abutment body having second internal pipe threads; and
said second end portion of said rack having second external pipe threads in substitution thereat for said ball screw threads;
wherein said second internal pipe threads of said second abutment body are threaded onto said second external pipe threads of said rack.

5. The electric power steering system with rack travel end stops of claim 4, wherein said second external pipe threads terminate at a second thread terminus adjoining said ball screw.

6. The electric power steering system with rack travel end stops of claim 5, wherein said second abutment body is tightly threaded in relation to said second thread terminus.

7. The electric power steering system with rack travel end stops of claim 6, wherein said first external pipe threads terminate at a first thread terminus spaced from the rack teeth; and wherein said first abutment body is tightly threaded in relation to said first thread terminus.

8. The electric power steering system with rack travel end stops of claim 2, wherein said second end portion of said rack is disposed at a ball screw of said rack, said ball screw comprising ball screw threads; and wherein the connection of said second abutment body to said second end portion of said rack comprises:
said second abutment body having internal ball screw threads;
wherein said internal ball screw threads of said second abutment body are threaded onto said ball screw threads of said rack.

9. The electric power steering system with rack travel end stops of claim 8, wherein said second abutment body is held in fixed threaded relation to said ball screw threads by a thread affixment agency.

10. The electric power steering system with rack travel end stops of claim 9, wherein said first external pipe threads terminate at a first thread terminus spaced from the rack teeth; and wherein said first abutment body is tightly threaded in relation to said first thread terminus.

11. The electric power steering system with rack travel end stops of claim 2, wherein said second end portion of said rack is disposed at a ball screw of said rack, said ball screw comprising ball screw threads; and wherein the connection of said second abutment body to said second end portion of said rack comprises:
said second abutment body having internal ball screw balls;
wherein said internal ball screw balls of said second abutment body are threaded onto said ball screw threads of said rack.

12. The electric power steering system with rack travel end stops of claim 11, wherein said second abutment body is held in fixed threaded relation to said ball screw threads by a thread affixment agency.

13. The electric power steering system with rack travel end stops of claim 12, wherein said first external pipe threads terminate at a first thread terminus spaced from the rack teeth; and wherein said first abutment body is tightly threaded in relation to said first thread terminus.

14. An electric power steering system with rack travel end stops, comprising:
a power steering rack, said rack having a first end portion and an oppositely disposed second end portion;
a rack housing having an internal passage, said rack being disposed in said internal passage in reciprocally movable relation with respect to said rack housing, said rack housing comprising a first housing abutment and a second housing abutment, said first and second housing abutments being disposed within said internal passage;
a first abutment body connected to said first end portion of said rack in concentrically external relation thereto;
a second abutment body connected to said second end portion of said rack in concentrically external relation thereto;
a first tie rod assembly connected to said first end portion of said rack; and
a second tie rod assembly connected to said second end portion of said rack;
wherein at a first extreme end of rack travel, said first abutment body abuts said first rack housing abutment to thereby stop rack travel at said first rack housing abutment free of said first tie rod assembly abutting said rack housing; and
wherein at a second extreme end of rack travel, said second abutment body abuts said second rack housing abutment to thereby stop rack travel at said second rack housing abutment free of said second tie rod assembly abutting said rack housing.

15. The electric power steering system with rack travel end stops of claim 14, wherein:
the connection of said first abutment body to said first end portion of said rack comprises:
said first abutment body having first internal pipe threads; and
said first end portion of said rack having first external pipe threads;
wherein said first internal pipe threads of said first abutment body are threaded onto said first external pipe threads of said rack; and
said second end portion of said rack is disposed at a ball screw of said rack; wherein the connection of said second abutment body to said second end portion of said rack comprises:
said second abutment body having second internal pipe threads; and
said second end portion of said rack having second external pipe threads in substitution of said ball screw thereat;
wherein said second internal pipe threads of said second abutment body are threaded onto said second external pipe threads of said rack; and
wherein said second abutment body is held in fixed threaded relation to said ball screw threads by a thread affixment agency.

16. The electric power steering system with rack travel end stops of claim 14, wherein:
the connection of said first abutment body to said first end portion of said rack comprises:
said first abutment body having first internal pipe threads; and
said first end portion of said rack having first external pipe threads;
wherein said first internal pipe threads of said first abutment body are threaded onto said first external pipe threads of said rack; and
said second end portion of said rack is disposed at a ball screw of said rack; wherein the connection of said second abutment body to said second end portion of said rack comprises:
said second abutment body having internal ball screw balls;
wherein said internal ball screw balls of said second abutment body are threaded onto said ball screw threads of said rack; and
wherein said second abutment body is held in fixed threaded relation to said ball screw threads by a thread affixment agency.

17. The electric power steering system with rack travel end stops of claim 14, wherein:
the connection of said first abutment body to said first end portion of said rack comprises:
said first abutment body having first internal pipe threads; and
said first end portion of said rack having first external pipe threads;
wherein said first internal pipe threads of said first abutment body are threaded onto said first external pipe threads of said rack; and
said second end portion of said rack is disposed at a ball screw of said rack; wherein the connection of said second abutment body to said second end portion of said rack comprises:
said second abutment body having internal ball screw threads;
wherein said internal ball screw threads of said second abutment body are threaded onto said ball screw threads of said rack; and
wherein said second abutment body is held in fixed threaded relation to said ball screw threads by a thread affixment agency.
